(19) United States
(12) Patent Application Publication
(10) Pub. No.: US 2021/0210114 A1
(43) Pub. Date: Jul. 8, 2021

(54) WEARABLE DEVICE INCLUDING A SOUND DETECTION DEVICE PROVIDING LOCATION INFORMATION FOR A BODY PART

(71) Applicant: Pison Technology, Inc., Brookline, MA (US)

(72) Inventors: Dexter W. Ang, Brookline, MA (US); David O. Cipoletta, Brookline, MA (US)

(21) Appl. No.: 16/737,252

(22) Filed: Jan. 8, 2020

(51) Int. Cl. G10L 25/51; H04R 1/02; G06F 3/16; G06F 3/01

(52) U.S. Cl. CPC G10L 25/51; G06F 3/011; G06F 3/165; H04R 1/025

(57) ABSTRACT

A wearable device includes a sound detection device. When a person wears the wearable device, the sound detection device captures sound in the person's environment and outputs an audio signal indicative of the sensed sound in the human-audible frequency range. Based on characteristics of the audio signal, a location or motion of the sound detection device with respect to a source of the sensed sound is computed. When the sound source is the person's voice, the computed location or motion represents the location or motion of the person's mouth with respect to the sound detection device. When the wearable device is worn on a body part, then the location or motion of that body part with respect to the person's mouth can be determined. A responsive device can use such location or motion information to allow user interaction with an application of the responsive device.

### BACKGROUND

Many human-machine interfaces attempt to sense location or motion of a wearable or handheld controller or other device, or of a body part, in some reference frame, to provide inputs to a computer system. For example, in virtual reality systems, such location or motion information often is used as an input to control an avatar in a virtual reality environment.

Current technologies for sensing location or motion have several drawbacks. For example, some devices sense such location or motion by using a camera to capture images and by performing image processing on those images. Such techniques consume significant power for the camera and for processors performing image processing. Image data also consumes significant bandwidth on communication channels.

Some devices sense location or motion by using accelerometers, gyroscopes, inertial measurement units, and the like. Such devices often detect location or motion information indirectly, by detecting acceleration. Position, orientation, velocity, and angular velocity typically are determined mathematically from signals generated by such devices, using a form of integration which introduces error which accumulates.

Some systems sense location or motion by having a person wear or hold a signal emitting device that emits a signal, and by monitoring the emitted signal using a receiver device. Such systems can be cumbersome for the user, consume battery power, and are not suitable for environments where emitting detectable signals is not desirable.

### SUMMARY

This Summary introduces a selection of concepts in simplified form that are described further below in the Detailed Description. This Summary neither identifies features as key or essential, nor limits the scope, of the claimed subject matter.

A wearable device, for a person to wear on their body, is equipped with at least one sound detection device. When the person wears the wearable device, a sound detection device senses sounds in the person's environment and generates a respective audio signal indicative of the sensed sound, for example, in the human-audible range. Based on characteristics of the audio signal, a location or motion of the sound detection device with respect to a reference point, such as the source of the sensed sound, is computed. The characteristics of the audio signal that can be used to compute the location include, but are not limited to, amplitude, time of arrival difference, amplitude differences, or beamforming techniques, or any combination of these. This location or motion can be computed without requiring the person to wear, or hold, or be near, a sound emitting device that generates a predetermined sound. Instead, the sensed sounds are generated either by the person, such as voice, breathing, or heartbeat, or by another person, or by something in the environment of the person, and are in the human-audible frequency range.

The term “location” is intended to mean any data describing, at least in part, position or orientation with respect to a reference point, a heading, or changes in any of these, such as velocity, angular velocity, acceleration, or angular acceleration, or any combination of two or more of these. The term “motion” is intended to signify a change in the position, orientation, or heading, or combination of these, with respect to the reference point. Motion information can be derived from information for two different moments in time. Within a frame of reference, such as a coordinate system associated with a person's body, the reference point may be absolute (such as an origin in a frame of reference) or relative (such as a previously known location). Different kinds of location sensors may use different reference points. Location may be represented in coordinates, in one, two, or three dimensions, whether in cartesian, radial, or spherical coordinates, or as a vector. Location also may be expressed in relative terms, such as high, low, left, right, far, and near. As used herein, “motion” of a body part such as the wrist is intended to signify a change in the position or orientation, or both, of the body part over time with respect to the reference point. Generally, a change in position or orientation of the top of the wrist is due to arm motion, and is referred to herein as wrist motion or arm motion.

In one implementation, the sound detection device comprises one or more microphones. Each microphone outputs a respective audio signal. When two or more microphones are used, location of a source of the sound with respect to the microphones can be computed based on differences in time of arrival of a sound at different microphones. Differences between other characteristics, such as but not limited to amplitude, phase, or frequency, of the audio signals from different microphones can be used.

When the sound source is the person's voice, the computed location represents the location of the person's mouth with respect to the microphones. When the location of the sound source with respect to the microphones is known, the location or motion of the microphones, and thus the body part on which the wearable device is worn, relative to a reference point can be reported. When the wearable device is worn at the top of the wrist (defined below), then the location or motion of the top of the wrist with respect to the person's mouth can be determined.

The audio signal output from the sound detection device can be processed to determine the location of other sound sources in the person's surroundings with respect to the sound detection device. For example, other sounds for which a location can be determined include, but are not limited to: a. other sounds generated from the person's body, such as breathing or heartbeat; b. sounds generated from another person's body, such as another person's voice, breathing, or heartbeat, c. sounds generated by other objects, such as machinery in a building. Nonetheless, the sound source in such cases is not a sound emitting device that generates a predetermined sound and which is worn or held by the person.

The wearable device can include other sensors that provide additional information. Such additional information can be used to help refine the processing performed on the audio signal output by the sound detection device to determine location of a sound source. The location information provided by processing the audio signal from the sound detection device also can supplement information generated from other sensors. Such other sensors can include any one or more of, but not limited to, a location sensor, such as an accelerometer, a gyroscope, an inertial measurement unit, or a geomagnetic sensor, a biopotential sensor, or a light sensor, or any combination of two or more of these.

Accordingly, in one aspect, an apparatus includes a wearable device and a sound source localization module. The wearable device has a housing configured to be secured on a movable body part of a person. The wearable device includes a sound detection device on the housing. The sound detection device has an output indicative of sensed sound in human-audible frequencies. The sound source localization module has an input connected to receive a signal based on the output of the sound detection device. The sound source localization module has an output providing an indication of a location of the sound detection device relative to a sound source.

In one aspect, an apparatus includes an input receiving data based on audio signals output by a sound detection device worn on a body part of a person. The audio signals are indicative of sound, in human-audible frequencies, sensed by the sound detection device. A sound source localization module has an input connected to receive the data received through the input. The sound source localization module has an output providing an indication of a location of the body part relative to a sound source. The apparatus includes an application responsive to the output to perform an operation according to the location of the body part.

In one aspect, an apparatus includes a wearable device and has an output. The wearable device has a housing configured to be secured on a movable body part of a person. The wearable device includes a sound detection device on the housing and having an output providing an audio signal indicative of sensed sound in human-audible frequencies. The apparatus has an output providing data based on the audio signal output by the sound detection device to a sound source localization module that computes an indication of a location of the sound detection device relative to a sound source.

In one aspect, a method includes sensing sound using a sound detection device on a movable body part of a person to generate an audio signal indicative of sensed sound in human-audible frequencies. The method further includes processing the audio signal to compute an indication of a location of the sound detection device relative to a sound source.

In one aspect, an apparatus includes a means for sensing sound in human-audible frequencies using a sound detection device on a movable body part of a person to generate an audio signal indicative of sensed sound and a means for processing the audio signal to compute an indication of a location of the sound detection device relative to a sound source.

Any of the foregoing aspects can include any one or more of the following features. The sound detection device comprises a plurality of microphones. Each microphone has an output indicative of sound sensed by the microphone. A controller is connected to the sound detection device. The controller has an output providing a sequence of digital audio samples as the output of the sound detection device. The wearable device includes a biopotential sensor. The biopotential sensor is configured to sense biopotentials noninvasively at a skin surface of the movable body part and has an output indicative of the sensed biopotentials. A controller is connected to the biopotential sensor. The controller is configured to provide a sequence of digital biopotential samples based on the sensed biopotentials. The wearable device includes a location sensor. The location sensor is on the housing. The location sensor senses location of the movable body part. The controller is connected to the location sensor. The controller is configured to provide a sequence of digital location samples based on the sensed location. The wearable location includes a feedback device. The feedback device is on the housing. The feedback device is configured to generate perceptible feedback to the person in response to a feedback input.

Any of the foregoing aspects can include any one or more of the following features. The sound source localization module is located at least in part in the wearable device. The sound source localization module is located at least in part in a responsive device. The apparatus includes a responsive device. The responsive device includes an application responsive to perform an operation according to the location of the body part. The application performs the operation based on at least the determined location or motion of the body part. The body part is the top of the wrist. The application performs the operation based on at least the determined location or motion of the wrist.

Any of the foregoing aspects can include any one or more of the following features. The sound source is the person's mouth and the sound is the person's voice. The determined location or motion is with respect to a reference point associated with the person's mouth. The sound source is not a sound emitting device that generates a predetermined sound. The sound source is not a sound emitting device that is worn or held by the person. The audio signals include sensed sounds at least in a range. The range is about 20 Hertz to 20000 Hz. The range is about 80 Hz to 260 Hz. The range is about 63 Hz to 8000 Hz.

The following Detailed Description references the accompanying drawings which forma part this application, and which show, by way of illustration, specific example implementations. Other implementations may be made without departing from the scope of the disclosure.

### BRIEF DESCRIPTION OF THE DRAWINGS

FIG. 1A is a schematic diagram of an illustrative, example implementation of a wearable device including a sound detection device.

FIGS. 1B-1D are schematic diagrams of example configurations of sound detection devices.

FIG. 2 is a block diagram of electrical components of an example implementation of a wearable device.

FIG. 3 is a block diagram of an example responsive device which communicates with a wearable device.

FIG. 4 is an illustrative example of how different locations of the wrist with respect to the mouth result in different determined angle and distance values based on a pair of microphones.

FIG. 5 is a block diagram of a general-purpose computer.

### DETAILED DESCRIPTION

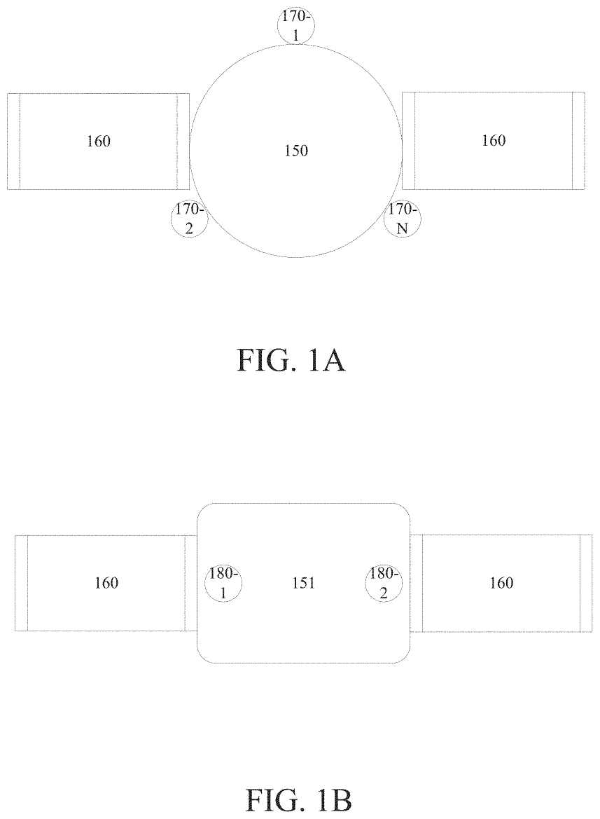

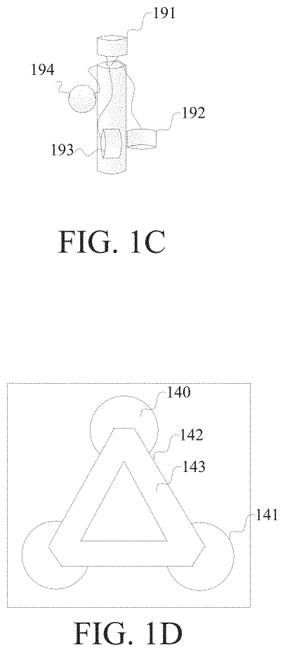

Referring to FIGS. 1A and 1B, a schematic diagram of an illustrative, example implementation of a wearable device including a sound detection device will now be described. This example implementation is a wrist-worn device, but such a wearable device could be worn on any movable body part of a person, such as an arm or leg, or any part of the arm or leg, such as the hand, wrist, finger, foot, ankle, or toe. The phrase “top of the wrist” as used herein is intended to mean the posterior surface of the arm at or near the distal end of the arm adjacent to the joint (the “wrist”) connecting the hand to the arm. As an example, the top of the wrist is where a wristwatch is typically worn.

In FIG. 1A, a housing 150 is connected to an attachment device 160, shown as a wrist band. The attachment device 160 allows the housing 150 to be attached to a movable body part, such as the wrist in this instance. While the shape of the housing 150 is shown in FIG. 1A as round, the housing can have any shape. For example, the shape of the housing 151 in FIG. 1B is shown as rectangular with rounded corners. Similarly, while the attachment device 160 is shown as a wrist band, the attachment device can be any mechanism that can be used to secure the housing 150 or 151 to the body part.

The wearable device includes a sound detection device. In the example shown in FIGS. 1A and 1B, the sound detection device comprises at least two microphones. In FIG. 1A, three microphones 170-1, 170-2, . . . , 170-N are shown (not to scale). In FIG. 1B, two microphone 180-1 and 180-2 are shown. In some cases, the microphones are equally spaced apart, to simplify computations performed when processing the audio signals output by the microphones. While three microphones are shown in FIG. 1A in a plane, it is possible to have more than three microphones in a single plane or in three dimensions. An example configuration of four microphones in three dimensions is a tetrahedron. Another example of a configuration of four microphones is shown in FIG. 1C. Another example of a microphone configuration is shown in FIG. 1D. Each microphone generates and outputs a respective audio signal indicative of sound sensed by the microphone.

Generally, each microphone is selected to have sufficiently broad dynamic range in the frequencies of sounds of interest. For example, if the sound source intended to be captured is a person's voice, then a microphone is selected which has a good dynamic range over a range of frequencies typical of a human voice.

Some frequency ranges of interest include, but are not limited to the frequency range of a human voice (approximately 80 Hertz to 260 Hertz), human-audible frequencies (20 Hz to 20 KHz), and acceptable frequencies for background noise (e.g., due to equipment) in buildings (63 Hz to 8000 Hz). Some example ranges of interest are therefore, a lower limit of about 0 Hz, 20 Hz, or 63 Hz, or 80 Hz, and an upper limit of about 260 Hz, 8000 Hz, or 20000 Hz.

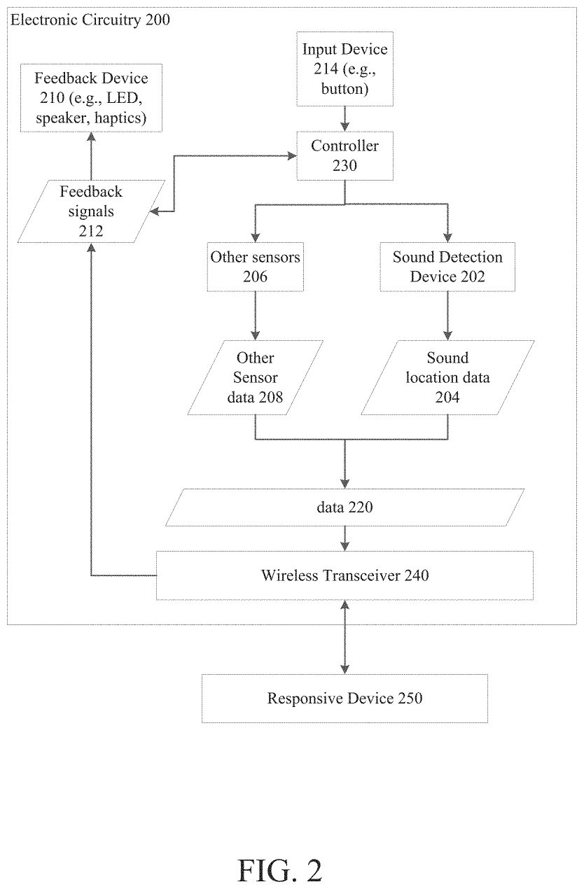

FIG. 2 schematically illustrates a block diagram of an example implementation of an electronic circuit 200, which can be mounted in the housing of the wearable device. The electronic circuit of the wearable device outputs data 220. The data 220 includes at least sound location data 204 indicative of a location of the body part on which the wearable device is worn relative to a location of a sensed sound.

The term “location” is intended to mean any data describing, at least in part, position or orientation with respect to a reference point, a heading, or changes in any of these, such as velocity, angular velocity, acceleration, or angular acceleration, or any combination of two or more of these. The term “motion” is intended to signify a change in the position, orientation, or heading, or combination of these, with respect to the reference point. Motion information can be derived from information for two different moments in time. Within a frame of reference, such as a coordinate system associated with a person's body, the reference point may be absolute (such as an origin in a frame of reference) or relative (such as a previously known location). Different kinds of location sensors may use different reference points. Location may be represented in coordinates, in one, two, or three dimensions, whether in cartesian, radial, or spherical coordinates, or as a vector. Location also may be expressed in relative terms, such as high, low, left, right, far, and near. As used herein. “motion” of a body part such as the wrist is intended to signify a change in the position or orientation, or both, of the body part over time with respect to the reference point. Generally, a change in position or orientation of the top of the wrist is due to arm motion, and is referred to herein as wrist motion or arm motion.

The data 220 also can include other sensor data 208 based on output signals of any other sensors 206. Other sensors 206 can include any one or more of, but not limited to, an accelerometer, a gyroscope, an inertial measurement unit, or a geomagnetic sensor, a biopotential sensor, or a light sensor, or any combination of two or more of these.

The data 204 and 208 are based on the output signals of their respective sensors. The data 204 and 208 thus may be the output signals from the sensors, or data representing information, such as a location, derived from processing those output signals, or data representing intermediate results, such as filtered signals or features, obtained from processing those output signals, or some combination of these.

One of the other sensors 206 may be a biopotential sensor that senses biopotentials at the location on the body where the wearable device is worn, such as at the top of the wrist. Biopotentials include electrical signals noninvasively sensed on the surface of the skin and are indicative of nerve signals transmitted to muscles, electrical activity of muscles in response to such nerve signals, and other electrical activity within tissues. When sensed at the top of the wrist, such biopotentials are related to activity of the muscles that control the hand and fingers, including movement of a single finger or groups of fingers with respect to the hand or to each other, and movement of the hand with respect to the arm, and any combination of these. The phrase “related to activity of muscles” is intended to include any one or more of nerve signals, muscle tissue signals, signals related to intended muscle movement (whether or not actualized), or signals related to unintended muscle movement (whether or not actualized), or any combination of two or more of these. The muscle movement may or may not be actualized depending on the condition of the person. The biopotential sensor provides one or more output signals, i.e., biopotential signals, indicative of the sensed biopotentials.

One of the other sensors 206 may be another location sensor. A location sensor senses the location of part of the body where the wearable device is worn, such as at the top of the wrist, with respect to a reference point. When sensed at the top of the wrist, the sensed location is indicative of the location of the wrist relative to this reference point. The location sensor provides an output signal indicative of the sensed location. An example of a commercially available product which can be used as the location sensor is a 9-axis sensor combining three types of devices (accelerometer, gyroscope, and geomagnetic sensors), such as a Bosch BNO055 absolute orientation sensor.

The wearable device also can include yet additional sensors of other types. Examples of types of sensors that can be used include, but are not limited to, any device that can sense, detect, or measure a physical parameter, phenomenon, or occurrence, such as global positioning system sensors, moisture sensors, temperature sensors, visible light sensors, infrared sensors, image capture devices such as cameras, audio sensors, proximity sensors, ultrasound sensors, radio frequency signal detectors, skin impedance sensors, pressure sensors, electromagnetic interference sensors, touch capacitance sensors, and combinations of them.

The wearable device also can output feedback, which is any stimulus which is perceptible to the person, through one or more feedback devices 210. The electronic circuit 200 may receive feedback signals 212 related to the feedback devices 210. The electronic circuit 200 may generate (e.g., by controller 230) the feedback signals 212 for the feedback devices 210. In some implementations, a feedback device may be present separate from the wearable device, instead of or in addition to any feedback device 210 in the wearable device. Example feedback devices include, but are not limited to, a haptic device (e.g., a vibration source), a light source (e.g., a light emitting diode or a display), a sound source (e.g., a speaker), or any combination of two or more of these or other feedback devices.

The electronic circuit also can include one or more input devices 214, such as buttons or switches, through which the person can provide explicit inputs to the electronic circuit 200. Such inputs can be for controlling the wearable device, such as powering on the device, initiating network connections, and controlling settings.

Components 202, 206, 210, and 214 interact with a controller 230. The controller is connected to the sound detection device 202 and sensors 206 to control operation of these components. The controller can include an analog-to-digital converter that samples, downsamples, or upsamples the outputs of the sound detection device 202 and sensors 206 so that the sound location data 204 and other sensor data 208 are a sequence of digital audio samples and a sequence of sensed samples, respectively, at a desired sampling rate. When the other sensors include a biopotential sensor, the other sensor data 208 includes a sequence of digital biopotential samples of the sensed biopotential signals. The controller 230 can include any other circuit that processes or conditions the data 204 and 208 prior to sampling, such as any amplifier or band pass, notch, high-pass or low-pass filtering.

The wearable device 200 is preferably wireless with respect to a responsive device 250, and may be powered by battery (not shown). A wireless wearable device communicates with a responsive device 250 (e.g., to send data 220 and receive feedback signals 212) through a wireless transceiver 240, such as a Bluetooth-compliant transceiver. While FIG. 2 illustrates sending data 220 to the responsive device, processing of the sound location data 204 and other sensor data 208 can be performed on the wearable device, or partially on the wearable device and partially on the responsive device or another device, or on or partially on another device, or on or partially on the responsive device.

The sound location data 204 are described as indicative of a location of a body part because the sound location data 204 can be processed to determine a location of a sound source with respect to the sound detection device on the wearable device on the body part. When the location of the sound source with respect to the sound detection device is known, and the location of the sound source can be treated as a reference point, then the location of the wearable device, and thus the body part on which the wearable device is worn, can be reported.

When the person wears the wearable device, the sound detection device senses sounds in the person's environment and generates an audio signal indicative of the sensed sound. Based on characteristics of the audio signal, a location or motion of the sound detection device with respect to a reference point, such as the source of the sensed sound, is computed. The characteristics of the audio signal that can be used to compute the location include, but are not limited to, amplitude, time of arrival difference, amplitude differences, or beamforming techniques, or any combination of these. This location or motion can be computed without requiring the person to wear, or hold, or be near, a sound emitting device that generates a predetermined sound. Instead, the sensed sounds are either generated by the person, such as voice, breathing, or heartbeat, or by another person, or by something in the environment of the person.

In one implementation, the sound detection device comprises one or more microphones. Each microphone outputs a respective audio signal. When two microphones are used, location of a source of the sound with respect to the microphones can be computed based on differences in time of arrival of a sound at different microphones.

When the sound source is the person's voice, the computed location represents the location of the person's mouth with respect to the microphones. When the location of the sound source with respect to the microphones is known, the location or motion of the microphones, and thus the body part on which the wearable device is worn, relative to a reference point can be reported. When the wearable device is worn at the top of the wrist, then the location of the top of the wrist with respect to the person's mouth can be determined.

The audio signal output from the sound detection device can be processed to determine the location of other sound sources in the person's surroundings with respect to the sound detection device. For example, other sounds for which a location can be determined include, but are not limited to: a. other sounds generated from the person's body, such as breathing or heartbeat; b. sounds generated from another person's body, such as another person's voice, breathing, or heartbeat, c. sounds generated by other objects, such as machinery in a building. Motion information can be derived from location information for two different moments in time.

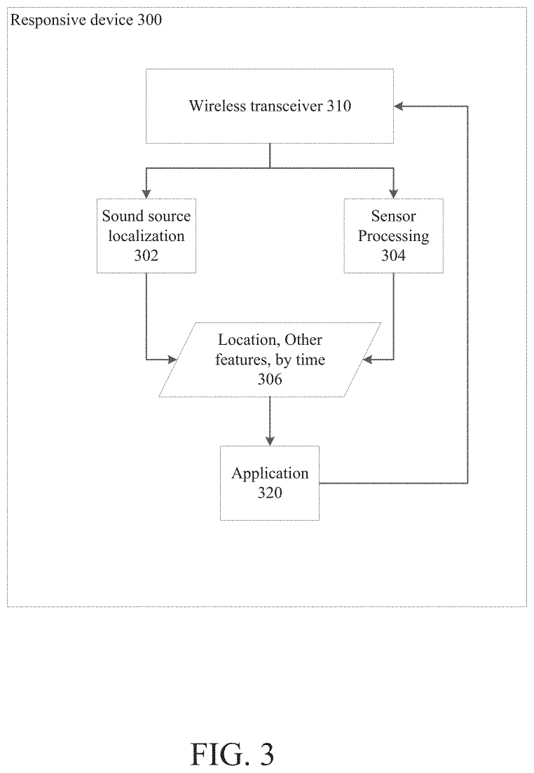

Referring now to FIG. 3, an example responsive device 300 which receives data from the wearable device will now be described. A responsive device 300 is a kind of machine, typically a computing device, which may be associated with one or more machines or one or more other computing devices, or both. The responsive device 300 is responsive to the wearable device to allow the person to interact with a machine, which may be the responsive device itself, or may be a machine or computing device associated with the responsive device.

In FIG. 3, the various items with which a person can interact through the responsive device are generically represented as an application 320. The application can cause feedback (e.g., feedback 212 in FIG. 2) to be provided to the person wearing the wearable device. In some instances, this feedback can be provided to the feedback device on the wearable device. In some instances, this feedback can be provided to a device separate from the wearable device, such as the responsive device.

In some implementations, the responsive device and the wearable device can be the same device. An example of such an implementation is a smart watch which incorporates the features of both the wearable device and the responsive device. In such implementations, the wireless transceiver (240, FIG. 2; 310, FIG. 3) can be omitted. In such an application, the data 220 (in FIG. 2) output from the sensors can be input directly to further processing modules that provide inputs to the application 320.

In the example shown in FIG. 3, the responsive device 300 is separate from the wearable device and includes a wireless transceiver 310 through which the responsive device receives data 220 (in FIG. 2) from the wearable device. This data 220 is processed to provide useful information (306) to the application 320 to allow the person to interact with the application. Generally, this information 306 includes, for each moment in time in an ongoing series of moments in time, an indication of a location of the body part on which the wearable device is worn at that moment in time, and other features extracted from or characteristics recognized in the received data 220 for that moment in time.

One form of information to be provided to the application 320 is the location of the body part, e.g., the wrist. This information is provided by a sound source localization module 302 by processing the sound location data 204 received from the wearable device. For example, the sound source localization module 302 can implement any algorithm for performing sound source localization given the number, type, and layout of microphones 170 (FIG. 1) on the housing.

The sound source localization module 302 also can reside within, or partially within, the wearable device, or another device, in addition to or alternatively to, residing within or partially within the responsive device. In some implementations, sound location data 204 from the sound detection device 202 can be transferred from the wearable device to another device for processing to determine the sound source location. In some implementations, sound location data 204 from the sound detection device 202 is processed on the wearable device to determine sound source location. In some implementations, sound location data 204 from the sound detection device is processed in part on the wearable device and in part on another device.

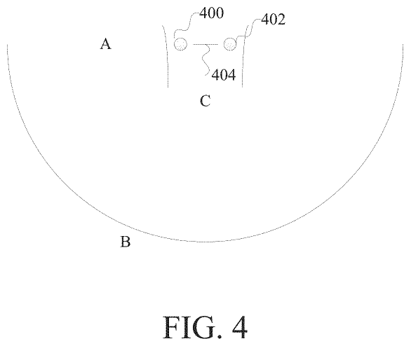

For example, referring to FIG. 4, consider only two microphones 400, 402 arranged in a line 404 perpendicular to the arm at the top of the wrist. If the person's wrist is near the mouth and the posterior surface of the arm is facing up, then the sound source localization would indicate that the mouth is at an angle and distance equivalent to point A, relative in FIG. 4. If the person's wrist is near the mouth and the posterior surface of the arm is facing the mouth, then the sound source localization would indicate that the mouth is at an angle and distance equivalent to point C in FIG. 4. If the person's arm is extending perpendicularly away from the body, then the sound source localization would indicate that the mouth is an angle and distance equivalent to point B in FIG. 4. While other wrist positions and orientations may result in similar outcomes, additional microphones or additional information from other sensors can help discriminate one location from another.

An example implementation of a sound detection device 202 and corresponding sound localization module 302 that can be used for this purpose is described in “Design of a Compact Sound Localization Device on a Stand-Alone FPGA-Base Platform”, by Mauricio Kugler et al., in IEICE Trans. Inf. & Syst., Volume E99-D, No. 11, November 2016, pp. 2682-2693 (“Kugler”). The Kugler reference is hereby incorporated by reference. A sound detection device and corresponding localization using two, three, or more microphones of different types, can be built using techniques described in Kugler, for which processing of audio signals can be performed, at least in part, on the responsive device.

Referring to FIG. 1B, a housing 150 can include a pair of microphones 180-1, 180-2. The microphones can be implemented using omnidirectional MEMS microphones, such as InvenSense microphones, such as the INMP441 microphone, available from the TDK Corporation. The spacing 190 between the microphones can be about 20 mm. A sampling rate of 48 kHz can be used. Using this configuration, time difference of arrival of a sound at the microphones can be used as the primary cue for determining location.

The time difference of arrival can be computed using what is known as the “Jeffress” model. In the Jeffress model, two anti-parallel delay lines receive a sequence of spikes over time, based on zero-crossings occurring in the audio signals from the microphones. Coincidence detectors connect different stages of the delay lines. A coincidence detector outputs a spike when its two inputs both are spikes. An index associated with a coincidence detector can be mapped to a sound direction. The audio signals are input to a band pass filter bank of multiple channels over a frequency range. The bandlimited signals are upsampled and input to a spike generator. The spike generator creates a sequence of spikes based on zero-crossings in a direction, such as in a downward direction. The sequence of spikes from each channel from each microphone are input to delay lines with coincidence detectors. The index of the coincidence detector in a given channel which has the maximum detection provides a time difference of arrival for that channel. An angle representing the sound direction is computed as a function of the indices obtained for the multiple channels. Such processing can be implemented in a field-programmable gate array (FPGA).

Each pair of microphones provides information about a sound direction. With three or more microphones, the sound directions derived for each pair can be combined to provide an estimate of distance to the sound source, with four microphones providing three-dimensional sound source localization.

Other techniques, such as a generalized cross-correlation or average magnitude difference function, also can be used to determine time difference of arrival.

Another example implementation of a sound detection device 202 and corresponding sound localization module 302 is described in “A Real-Time 3D Sound Localization System with Miniature Microphone Array for Virtual Reality”, by Shengkui Zhao et al., in Proceedings of the 2012 7th IEEE Conference on Industrial Electronics and Applications, ICIEA 2012, July 2012, pp. 1853-1857 (“Zhao”). The Zhao reference is hereby incorporated by reference.

Referring to FIG. 1C, such a set of microphones includes three bidirectional pressure gradient microphones with a figure-eight response, oriented orthogonally in three dimensions x, y, and z (194 (x), 193 (y), and 192 (z)). A fourth acoustic pressure microphone 191 is omnidirectional. In this implementation, the amplitude differences of the signals from the pressure gradient microphones are the primary cues used for sound localization. The direction of arrival of a sound can be determined using the Capon beamformer or multiple signal classification (MUSIC) methods.

Another example implementation of a sound detection device 202 and corresponding sound localization module 302 is described in “Fly-ear inspired micro-sensor for sound source localization in two dimensions”, by A. P. Lisiewski et al., in J. Acoust. Soc. Am., Volume 129. Number 5, May 2011, pp. EL166-EL171 (“Lisiewski”). The Lisiewski reference is hereby incorporated by reference.

Referring to FIG. 1D, such a fly-ear inspired sensor includes three circular membranes, e.g., 140 in a configuration of an equilateral triangle defined by the centers of the membranes. The membranes are secured to a substrate at their peripheries, e.g., 141. A set of beams 142 forming a triangle couples the membranes, with each beam coupling the centers of two membranes. Each beam pivots about its center 143 which is also affixed to the substrate. The sensor is effectively a system of three mass-spring-damper subsystems which oscillate in response to a sound wave and has rocking and bending modes. These rocking and bending modes provide the primary cues for sound localization. The oscillations of the membrane can be detected in several ways, such as optically or capacitively.

It should be understood that a combination of such devices and techniques can be used for sound detection and localization.

Another form of information to be provided to the application 320 includes any other features or characteristics detected in the other sensor data (208 in FIG. 2) received from the wearable device. This information can be generated, for example, by a sensor processing module 304.

When the other sensors include a biopotential sensor, this information can include features extracted from the biopotential signals, such as mean absolute value, energy ratios, frequency information, and the like. This information can include a characterization of the biopotential signal as representing a pose or movement of the hand, or one or more fingers of the hand, or both.

The additional information from the other sensors also can be used to help refine sound source localization performed on the signals output by the sound detection device. Conversely, the location or motion information provided by sound source localization also can supplement location information generated from the other sensors.

For example, the location information provided based on the audio signals from a pair of microphones is an angle with respect to a line between a pair of microphones and a distance from a midpoint of that line to the sound source. The information obtained from one or more of an accelerometer, gyroscope, geomagnetic sensor, or inertial measurement unit, can provide additional orientation information or position information, or both, for the body part. When the wearable device is worn on the wrist, the angle and distance based on the sound detection device indicates the location of the wrist with respect to the person's mouth, and other orientation and position information from other sensors can provide other indicia about the position, orientation, or motion, of the wrist. The distance and angle information from each pair of microphones can assist in discriminating whether the wrist is near or far from the mouth, and orientation of the top of the wrist with respect to the mouth, such as when the forearm is extending perpendicularly away from the body, or when the arm is bent and the forearm is parallel with the body.

Given the information 306, an application 320 can perform a wide variety of different operations. For example, an application 320 can perform an operation based on the location or motion of the body part based on signals from the sound detection device, or based on a feature or characteristic based on signals from other sensors, or both. Application 320 can cause information, such as feedback, to be transmitted back to the wearable device through the wireless transceiver 310. A broad range of user interactions can be performed by the application, including those described in one or more of the following:
a. U.S. patent application Ser. No. 16/104,273, filed Aug. 17, 2018, pending, which is a continuation of U.S. patent application Ser. No. 15/826,133, now U.S. Pat. No. 10,070,799 issued Sep. 11, 2018, which is a nonprovisional application of U.S. provisional patent application 62/566,674, filed Oct. 7, 2017, and U.S. provisional patent application 62/429,334, filed Dec. 2, 2016;
b. U.S. patent application Ser. No. 16/055,123, filed Aug. 5, 2018, pending;
c. U.S. patent application Ser. No. 16/246,964, filed Jan. 14, 2019, pending; and
d. PCT Patent application serial number PCT/US19/061421, filed Nov. 4, 2019, pending, which is an international application designating the United States claiming priority to U.S. patent application Ser. No. 16/196,462, filed Nov. 20, 2018, pending; and
e. All the foregoing are hereby incorporated by reference.

The responsive device, sound source localization module, and application can be implemented using a general-purpose computer and computer programs running on such a computer.

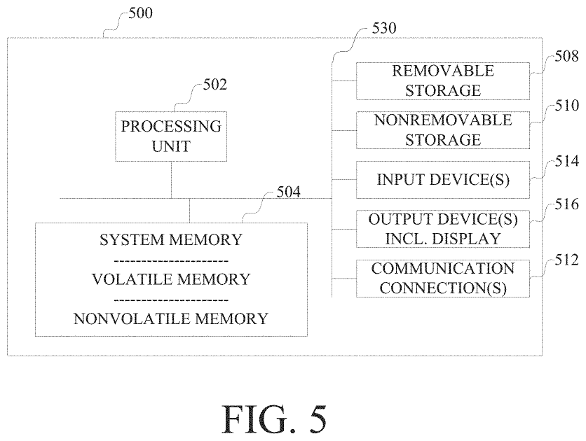

Having now described several example implementations, FIG. 5 illustrates an example of a general-purpose computing device with which can be used to implement a responsive device or other computer systems used in connection with such responsive devices. This is only one example of a computer and is not intended to suggest any limitation as to the scope of use or functionality of such a computer. The system described above can be implemented in one or more computer programs executed on one or more such computers as shown in FIG. 5.

FIG. 5 is a block diagram of a general-purpose computer which processes computer program code using a processing system. Computer programs on a general-purpose computer generally include an operating system and applications. The operating system is a computer program running on the computer that manages access to various resources of the computer by the applications and the operating system. The various resources generally include memory, storage, communication interfaces, input devices and output devices.

Examples of such general-purpose computers include, but are not limited to, larger computer systems such as server computers, database computers, desktop computers, laptop and notebook computers, as well as mobile or handheld computing devices, such as a tablet computer, hand held computer, smart phone, media player, personal data assistant, audio or video recorder, or wearable computing device.

With reference to FIG. 5, an example computer 500 comprises a processing system including at least one processing unit 502 and a memory 504. The computer can have multiple processing units 502 and multiple devices implementing the memory 504. A processing unit 502 can include one or more processing cores (not shown) that operate independently of each other. Additional co-processing units, such as graphics processing unit 520, also can be present in the computer. The memory 504 may include volatile devices (such as dynamic random access memory (DRAM) or other random access memory device), and non-volatile devices (such as a read-only memory, flash memory, and the like) or some combination of the two, and optionally including any memory available in a processing device. Other memory such as dedicated memory or registers also can reside in a processing unit. This configuration of memory is illustrated in FIG. 5 by dashed line 504. The computer 500 may include additional storage (removable or non-removable) including, but not limited to, magnetically-recorded or optically-recorded disks or tape. Such additional storage is illustrated in FIG. 5 by removable storage 508 and non-removable storage 510. The various components in FIG. 5 are generally interconnected by an interconnection mechanism, such as one or more buses 530.

A computer storage medium is any medium in which data can be stored in and retrieved from addressable physical storage locations by the computer. Computer storage media includes volatile and nonvolatile memory devices, and removable and non-removable storage devices. Memory 504, removable storage 508 and non-removable storage 510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 500 may also include communications connection(s) 512 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 512 are devices, such as a network interface or radio transmitter, that interface with the communication media to transmit data over and receive data from signals propagated through communication media.

The communications connections can include one or more radio transmitters for telephonic communications over cellular telephone networks, or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 500 may have various input device(s) 514 such as various pointer (whether single pointer or multi-pointer) devices, such as a mouse, tablet and pen, touchpad and other touch-based input devices, stylus, image input devices, such as still and motion cameras, audio input devices, such as a microphone. The compute may have various output device(s) 516 such as a display, speakers, printers, and so on, also may be included. These devices are well known in the art and need not be discussed at length here.

The various storage 510, communication connections 512, output devices 516 and input devices 514 can be integrated within a housing of the computer, or can be connected through various input/output interface devices on the computer, in which case the reference numbers 510, 512, 514 and 516 can indicate either the interface for connection to a device or the device itself as the case may be.

An operating system of the computer typically includes computer programs, commonly called drivers, which manage access to the various storage 510, communication connections 512, output devices 516 and input devices 514. Such access generally includes managing inputs from and outputs to these devices. In the case of communication connections, the operating system also may include one or more computer programs for implementing communication protocols used to communicate information between computers and devices through the communication connections 512.

Any of the foregoing aspects may be embodied as a computer system, as a component of such a computer system, as a process performed by such a computer system or a component of such a computer system, or as an article of manufacture including computer storage in which computer program code is stored and which, when processed by the processing system(s) of one or more computers, configures the processing system(s) of the one or more computers to provide such a computer system or a component of such a computer system.

Each component (which also may be called a “module” or “engine” or the like), of a computer system and which operates on one or more computers, can be implemented as computer program code processed by the processing system(s) of one or more computers. Computer program code includes computer-executable instructions or computer-interpreted instructions, such as program modules, which instructions are processed by a processing system of a computer. Generally, such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated and stored by a processing system of a computer.

It should be understood that the subject matter defined in the appended claims is not necessarily limited to the specific implementations described above. The specific implementations described above are disclosed as examples only.

What is claimed is:

1. An apparatus comprising:
A. a wearable device comprising:
i. a housing configured to be secured on a movable body part of a person wherein the body part comprises the top of a wrist of the person, and
ii. a sound detection device on the housing and having an output indicative of sensed sound having human-audible frequencies; and
B. a sound source localization module having an input connected to receive a signal based on the output of the sound detection device and having an output providing an indication of a location of the body part relative to a sound source wherein the sound source comprises the person's mouth and the sound comprises the person's voice, wherein the location of the body part is in reference to a point associated with the person's mouth.

2. The apparatus of claim 1, wherein the sound detection device comprises a plurality of microphones, each microphone having an output indicative of sound sensed by the microphone.

3. The apparatus of claim 1, further comprising a controller connected to the sound detection device and having an output providing a sequence of digital audio samples as the output of the sound detection device.

4. The apparatus of claim 3, wherein the wearable device further comprises:
a biopotential sensor configured to sense biopotentials noninvasively at a skin surface of the movable body part and having an output indicative of the sensed biopotentials; and
wherein the controller is further connected to the biopotential sensor and is further configured to provide a sequence of digital biopotential samples based on the sensed biopotentials.

5. The apparatus of claim 1, wherein the wearable device further comprises:
a biopotential sensor configured to sense biopotentials noninvasively at a skin surface of the movable body part and having an output indicative of the sensed biopotentials.

6. The apparatus of claim 3, wherein the wearable device further comprises:
a location sensor on the housing and sensing location of the movable body part; and
wherein the controller is further connected to the location sensor and further is configured to provide a sequence of digital location samples based on the sensed location.

7. The apparatus of claim 1, wherein the wearable device further comprises:
a location sensor on the housing and configured to sense location of the movable body part.

8. The apparatus of claim 1, wherein the wearable device further comprises:
a feedback device configured to generate perceptible feedback to the person in response to a feedback input.

9. The apparatus of claim 1, wherein the sound source localization module is located at least in part in the wearable device.

10. The apparatus of claim 1, wherein the sound source localization module is located at least in part in a responsive device.

11. The apparatus of claim 1, further comprising a responsive device, wherein the responsive device comprises:
an application responsive to perform an operation according to the location of the body part.

12. The apparatus of claim 11, wherein the application performs the operation based on at least the determined location or motion of the body part.

13. (canceled)

14. (canceled)

15. (canceled)

16. (canceled)

17. The apparatus of claim 1, wherein the sound source is not a sound emitting device that generates a predetermined sound and which is worn or held by the person.

18. The apparatus of claim 1, wherein the audio signals include sensed sounds at least in a range of 20 Hertz to 20000 Hz.

19. The apparatus of claim 18, wherein the range is between 80 Hz to 260 Hz.

20. The apparatus of claim 18, wherein the range is between 63 Hz to 8000 Hz.

21. An apparatus comprising:
an input receiving data based on audio signals output by a sound detection device worn on a body part of a person, wherein the audio signals are indicative of sound, in human-audible frequencies, sensed by the sound detection device, wherein the body part comprises the top of a wrist;
a sound source localization module having an input connected to receive the data received through the input and having an output providing an indication of a location of the body part relative to a sound source, wherein the sound source comprises the person's mouth and the sound comprises the person's voice, wherein the location of the body part is in reference to a pint associated with the person's mouth; and
an application responsive to the output to perform an operation according to the location of the body part.

22. An apparatus comprising:
A. a wearable device comprising:
i. a housing configured to be secured on a movable body part of a person wherein the body part comprises the top of a wrist, and
ii. a sound detection device on the housing and having an output providing an audio signal indicative of sensed sound in human-audible frequencies; and
B. an output providing data based on the audio signal output by the sound detection device to a sound source localization module that computes an indication of a location of the body part relative to a sound source, wherein the sound source comprises the person's mouth and the sound comprises the person's voice, wherein the location of the body part is in reference to a point associated with the person's mouth.

23. A method comprising:
sensing sound using a sound detection device on movable body part of a person to generate an audio signal indicative of sensed sound in human-audible frequencies wherein the body part comprises the top of a wrist; and
processing the audio signal to compute an indication of a location of the sound detection device relative to a sound source, wherein the sound source comprises the person's mouth and the sound comprises the person's voice, wherein the location of the body part is in reference to a pint associated with the person's mouth.

24. The method of claim 23, further comprising:
providing the indication of the location of the sound to an application on a responsive device;
the application performing an operation according to the location of the body part.
